(19) United States
(12) Patent Application Publication
(10) Pub. No.: US 2003/0198841 A1
(43) Pub. Date: Oct. 23, 2003

(54) Municipal sludge gasified for production of electricity from fuel cells

(76) Inventor: Gene E. Lightner, Federal Way, WA (US)

Correspondence Address: Gene E. Lightner, 706 SW 296th St., Federal Way, WA, 98023, US

(21) Appl. No.: 10/127,199

(22) Filed: Apr. 22, 2002

(51) Int. Cl. H01M 8/06; H01M 8/14

(52) U.S. Cl. 429/17; 429/16

(57) ABSTRACT

Production of electricity originates by providing a supply of municipal sludge and a vessel for gasification and subjecting the municipal sludge to gasification to afford access to fuel cells; thereupon conveying products of gasification to a stack of fuel cells and providing air to the fuel cells for reaction of oxygen within air, hence generating direct current. Residue, remaining from gasification, is subjected to disposal. Thereby direct current from a stack of fuel cells is generated by gasification of municipal sludge.

### BACKGROUND OF THE INVENTION

Creation of waste sludge is unavoidable in a municipality having sewers. Unwanted solids disposal has recently become a major problem. Municipal sludge is dewatered, within a process disclosed within U.S. Pat. No. 6,030,538 wherein dewatered municipal sludge is produced on a belt press to remove drained water. Municipal sludge, previously dewatered, is subjected to high electrical voltages to rupture membranes within cellular units to release additional water, revealed within U.S. Pat. No. 6,030,538. Harmful pathogens such as viruses and bacteria, contained within municipal sludge, are rendered harmless, pointed out within U.S. Pat. No. 5,365,676 wherein heated air is supplied directly to municipal sludge for uniform and rapid drying to produce solids suitable for direct land application. Often the sludge is transported to a land fill for degradation. At times the sludge is dried and digested in soil to provide a fertilizer. “Method for direct gasification of solid waste material” is the title of U.S. Pat. No. 5,423,891 wherein one such solid waste material is municipal sludge subjected to direct gasification to produce a high BTU content fuel gas. Gasification products, carbon dioxide, water and volatile organic compounds are subjected to reforming and steam shifting to create hydrogen and carbon dioxide. These procedures are accomplished by high temperature fuel cells, such as a stack of fuel cells selected from the group consisting of molten carbonate fuel cells, solid oxide fuel cells or a combination thereof. These high temperature fuel cells react with oxygen within air, simultaneously reforming volatile organic compounds and accomplish steam shifting to create hydrogen. The hydrogen reacts within the fuel cells to create direct current and water. Various descriptions of internal reforming, employing stacks of fuel cells operating at high temperature are found, for example, within U.S. Pat. No. 6,344,289, U.S. Pat. No. 6,200,696 and U.S. Pat. No. 6,110,614, to accomplish reforming of hydrocarbon fuel to form hydrogen without utilizing a catalyst. Exothermic heat generated by the reaction of hydrogen and oxygen can be used for gasification of solid waste material.

It is therefore an object of this invention to obviate many of the limitations or disadvantages of the prior art.

A principal object of this invention is to produce electrical power by gasification of solid waste material

A distinct object of this invention is to employ a stack of fuel cells, operating at high temperature to generate electrical power

A further object of this invention is to achieve internal reforming of volatile organic compounds within fuel cells.

Another object of this invention is to furnish exothermic thermal energy, generated within fuel cells, for gasification of solid waste material, requiring endothermic heat.

Furthermore a fundamental object of this invention is gasification of solid waste material.

Still another object of this invention is to convert direct current, generated by fuel cells, to alternating current.

Yet another object of this invention is produce alternating current of the same electrical phase as the alternating current within a power grid.

An additional object of this invention is transform alternating current to voltage compatible with a power grid.

With the above and other objects in view, this invention relates to the novel features and alternatives and combinations presently described in the brief description of the invention.

### APPLIED BACKGROUND OF THE INVENTION

A principle, applied in the present invention, employs vacuum filtration of municipal sludge to produce a cake of dewatered sludge as described within CHEMICAL ENGINEER'S HANDBOOK, third edition, 1950, page 9896, edited by Perry et al. A practice applied within the present invention, is gasification of dewatered sludge, similar to biomass gasification, commonly acknowledged. High temperature fuel cells that accomplish this are for example, molten carbonate fuel cells and solid oxide fuel cells. High temperature fuel cells reacting with oxygen within air, simultaneously reform volatile organic compounds and accomplish steam shifting. Municipal sludge gasification, producing volatile organic compounds and carbon monoxide, transmitted to fuel cells, will produce hydrogen to react with oxygen in air to form water within the fuel cells. Fuel cells form direct current and exothermic heat. Exothermic heat is then employed for municipal sludge gasification, which requires endothermic heat. Direct current formed from fuel cells is converted to alternating current. This operation is performed by well known equipment referred to as an AC/DC inverter. Alternating current, thus created, is transformed to increase the voltage level with a transformer for subsequent access to a power grid. Electrical phase of the alternating current must match that within the power grid, for compatibility. Water is reacted with carbon monoxide to shift carbon monoxide to carbon dioxide and form hydrogen, within the reversible chemical formula, H₂O+CO [symbol] CO₂+H₂ provided in Chemical Process Industries, second edition, authored by R. N. Shreve, page 121. At high temperatures, found within fuel cells, the reaction is accelerated and the hydrogen which upon reacting within fuel cells reduces hydrogen in the equilibrium to facilitate shifting of carbon monoxide existing within gasification of dewatered sludge. Accordingly a catalyst for shifting is unnecessary. According to “DOD fuel cell descriptions,” page 2, detected on the internet, 2002, sulfur is tolerant within solid oxide fuel cells by several orders of magnitude greater than other fuel cells. Hence sulfur within gasification of dewatered sludge is of little consequence to poisoning within solid oxide fuel cells

### BRIEF DESCRIPTION OF THE INVENTION

The present invention in its broadest aspect, establishes a method to produce electricity from fuel cells powered by gasification of a municipal sludge which comprises: providing a supply of municipal sludge and a vessel for gasification and providing a stack of fuel cells and subjecting the municipal sludge to gasification within the vessel. Consequent to conveying products of gasification to the stack of fuel cells and providing air to the stack of fuel cells for reaction of oxygen within air will generate direct current from the stack of fuel cells. Accordingly the residue remaining from gasification is subject to disposal thereby direct current from a stack of fuel cells is generated by gasification of municipal sludge.

Characteristics of the invention include:

Municipal sludge is substantially dewatered and subjected to gasification to provide products of gasification.

Products of gasification are conveyed to a stack of fuel cells operated at a predetermined temperature from about 500 to about 1000 degrees Celsius.

The stack of fuel cells is supplied with air to generate direct current and water vapor.

The fuel cells generate exothermic heat and transports heat by thermal conduction to the vessel for gasification, maintained at a temperature of about 500 to about 1000 degrees Celsius.

The direct current is transformed to alternating current which is utilized within a transformer to produce alternating current with the same electrical phase and voltage compatible with a power grid.

The stack of fuel cells is selected from the group consisting of molten carbonate fuel cells, solid oxide fuel cells or a combination thereof

The method is performed in a continuous manner.

The fuel cells are stacked in layers enclosed by metal layers.

Organic compounds are converted within fuel cells to form hydrogen and carbon dioxide.

The vessel for gasification is pressurized from about 5 atmospheres to about 10 atmospheres.

The supply of municipal sludge is subjected to pyrolysis

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to convert direct current to alternating current.

### DETAILED DESCRIPTION OF THE PREFERRED EMBODIMENT

In the preferred embodiment of the present invention production of direct current from a stack of fuel cells by gasification of a municipal sludge is accomplished.

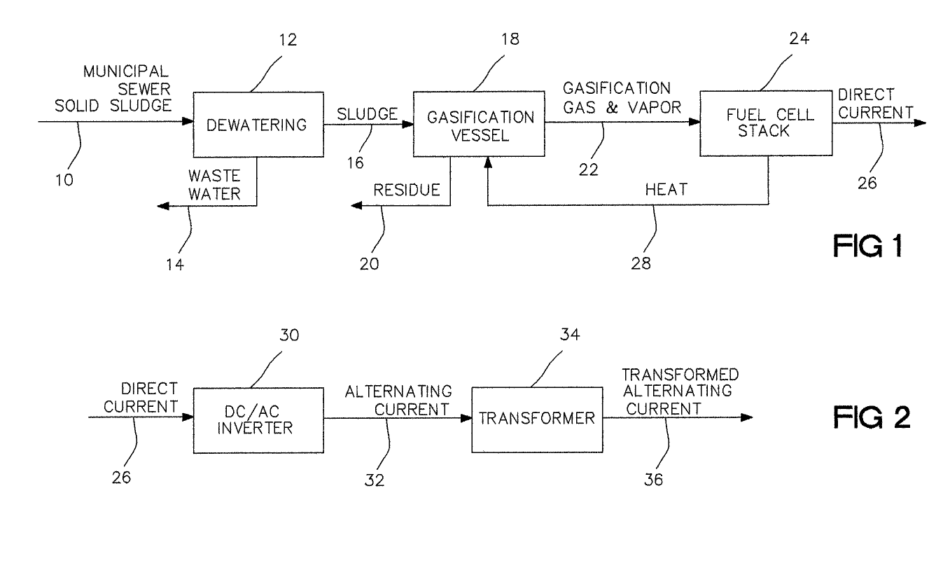

The flow diagram of FIG. 1 illustrates the general preferred embodiment of the present invention. In the diagram, rectangles represent stages, operations or functions of the present invention and not necessarily separate components. Arrows indicate direction of flow in the method. The method portrayed in FIG. 1 will take place from municipal sewer sludge, subject to gasification, supplied to a fuel cell stack to result in formation of direct current.

Referring to FIG. 1, municipal sewer sludge 10 is conveyed to dewatering stage 12 to result in waste water 14 and dewatered sludge 16. Dewatered sludge 16 is subjected to gasification vessel 18 to create gasification gas and vapor 22 supplied to fuel cell stack 24 and residue 20 for disposal. Fuel cell stack 24 generates direct current 26 and creates exothermic heat 28. Heat 28 is conducted to gasification vessel 18 for endothermic gasification. Observe that dewatered sludge 16, subjected to gasification to form gas and vapor, pathogens within municipal sewer sludge are destroyed 10. Sulfur existing within gasification is insufficient to poison fuel cells within fuel cell stack 24. Waste water 14, is routinely subjected to treatment before release to water containing environment.

Referring to FIG. 2, direct current 26 from fuel stack 24 is inverted from direct current to alternating current by DC/AC inverter 30 to create alternating current 32 to be transferred to transformer 34 to provide transformed alternating current 36. Transformed alternating current 36, in electrical phase with a power grid, is admitted to the power grid.

What is claimed is:

1. A method to produce electricity from fuel cells powered by gasification of a municipal sludge, which comprises:
providing a supply of municipal sludge
providing a vessel for gasification
providing a stack of fuel cells
subjecting said municipal sludge to gasification within said vessel, and
conveying products of gasification to said stack of fuel cells, and
providing air to said stack of fuel cells for reaction of oxygen within said air, and
generating direct current from said stack of fuel cells,
remaining residue from gasification is disposed thereby direct current from a stack of fuel cells is generated by gasification of municipal sludge.

2. The method of claim 1 wherein said direct current is transformed to alternating current.

3 The method of claim 2 wherein the alternating current is utilized within a transformer to produce alternating current of voltage for a power grid.

4. The method of claim 2 wherein the alternating current is of the same electrical phase as said power grid.

5. The method of claim 1 wherein said stack of fuel cells is selected from the group consisting of molten carbonate fuel cells, solid oxide fuel cells or a combination thereof.

6. The method of claim 1 wherein the method is continuous.

7. The method of claim 1 wherein said vessel for gasification is maintained at a temperature of about 500 to about 1000 degrees Celsius.

8. The method of claim 1 wherein said fuel cells are operated at a predetermined temperature from about 500 to about 1000 degrees Celsius.

9. The method of claim 1 wherein said fuel cells generate exothermic heat and transports heat by thermal conduction to said vessel.

10. The method of claim 9 wherein the fuel cells transports exothermic heat by a metal.

11. The method of claim 1 wherein said fuel cells are stacked in layers enclosed by metal layers.

12. The method of claim 1 wherein said municipal sludge subjected to gasification contains sulfur compounds.

13. The method of claim 12 wherein the sulfur compounds are insufficient to poison said fuel cells.

14. The method of claim 1 wherein said municipal sludge, subjected to gasification, contains organic compounds.

15. The method of claim 14 wherein the organic compounds are converted within said fuel cells to form hydrogen.

16. The method of claim 1 wherein said municipal sludge is subjected to dewatering to substantially remove water from the sludge.

17. The method of claim 1 wherein said vessel for gasification is pressurized from about 5 atmospheres to about 10 atmospheres.

18. The method of claim 1 wherein said supply of municipal sludge is subjected to pyrolysis.
